(19) United States
(12) Patent Application Publication
(10) Pub. No.: US 2007/0100833 A1
(43) Pub. Date: May 3, 2007

(54) E-bookmark

(75) Inventors: Xin Chen, Shanghai (CN); Ningjiang Chen, Shanghai (CN); Yongqin Zeng, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/596,180

(22) PCT Filed: Dec. 7, 2004
(86) PCT No.: PCT/IB04/52678

§ 371 Date: Jun. 2, 2006

(30) Foreign Application Priority Data
Dec. 9, 2003 (CN) 200310122528.8

(51) Int. Cl. G06F 17/30

(52) U.S. Cl. 707/10

(57) ABSTRACT

The present invention provides a method for creating an electronic bookmark during browsing on a web. According to a predetermined sequence the method records the process of browsing the specific program content by an user and stores the process in a storing means. The stored content is a browsing command for requiring a specific server to send the program content from an random position in a specific program specified by an user. When a user clicks the bookmark, a series of requests contained in the bookmark are handled one by one in the batch-handling manner, so that the user can directly and accurately find the specific position in the specific program in a on-line manner in the web, as conveniently as using conventional bookmarks in the conventional books.

### BACKGROUND OF THE INVENTION

The present invention relates to an e-bookmark, and particularly to an e-bookmark used on the web.

As a new way of study and entertainment, web multimedia is becoming more and more popular among the public. The content of web multimedia is used in two ways now: one is off-line, this multimedia content is stored in a local storing device, e.g. Personal Digital Assistant (PDA), where the user could browse the book off-line at any time; the other is on-line, this multimedia content is stored in a web server to which the user could connect in a wired or wireless manner and browse the book on-line. As the web bandwidth getting wider, the stability of web transmission getting better, and at the same time, being on-line does not occupy the local storage resource, this manner is growing more popular among users. In addition, for the sake of copyright protection, the web content service provider is inclined to store the multimedia content in a web server in a uncopiable form for users to browse it on-line.

FIG. 1 is a general system schematic diagram of browsing streaming media on the web under the control of RTSP methods. All users (user 1, user 2, . . . , user n) could create connection with one or more streaming servers (streaming server 1, streaming server 2, . . . , streaming server m) through RTSP methods and responses, and continuously obtain specific streaming media from the streaming server under the control of RTSP.

The web information content browsed on-line is transmitted over the web mainly in the manner of streaming media. RTSP (Real Time Streaming Protocol) is a streaming media control protocol for creating and controlling one or more continuous streaming media of time synchronization. Although it is possible to multiplex continuous media stream and control flow together, usually the RTSP itself does not transmit continuous stream. In other words, RTSP acts as the web remote control of multimedia server.

Being expandable, analytical, safe, independent of transmission, and supported by multiple servers, RTSP enjoys extensive support both from various streaming media formats such as mpg, rm, mov and the like, and from dominating media server/player such as Windows Media Server/Player of Microsoft Corporation, Helix Server/RealOne player of RealNetworks Corporation, and Quicktime Server/Player of Apple Corporation and the like.

RTSP methods are a set of requests for creating and controlling continuous streaming media, e.g. SETUP, PLAY, RECORD, PAUSE and TEARDOWN. The objects of the methods of request are defined by presentation description, which usually comprises objects (such as the web address of one or more media streams) on which the methods act and the information of the objects. The presentation description may have several different formats, including SDP (Session Description Protocol, IETF protocol RFC 2327).

When the user browses a conventional book (i.e. a book presented to the user in the form of printed material), bookmark is a very common tool for marking. The user could use the bookmark to mark his favorite fragment or the position where he last left off. When the user browses the web multimedia, he also hopes to have similar tools, such as e-bookmark, to implement the function similar to the conventional bookmark.

All the existing browsing tools of streaming media, e.g. media player, have considered adding the function of e-bookmark(electronic bookmark). For example, Windows Media Player could place the storage position of the streaming media content on the web, i.e. URL (Uniform Resource Locator), to the Favorites.

However, this method could only enable the user to find the specific streaming media on the web, but could not enable the user to conduct accurate positioning in the whole content of said streaming media as he wants. RealOne Player provides the multimedia content user with a new function, which could add the start position of the user's favorite fragment to his Favorites, but this only applies to the multimedia content stored locally in an off-line manner, being inapplicable on the web in an on-line manner. Quicktime Player could record a fragment of the streaming media and this fragment could have specific start and end time.

However, no matter what initial format the streaming media have, the recorded information could only be stored in .mov format, so other media players like RealOne Player may not be able to play it.

As a result, a new e-bookmark and a new method of creating e-bookmark are desired so that the user could achieve the marking function of a conventional bookmark in an on-line manner.

### SUMMARY OF THE INVENTION

The object of this invention is to eliminate the above defects of the existing e-bookmark.

The present invention provides a new e-bookmark, which comprises a browsing command for requiring a specific server to send a specific program from an random position specified by a user. Said browsing command could comprise a series of requests, which may include a connection request for establishing connection with the server, wherein the program is stored in the server; and a playing request for requiring the server to send the specific program from the first random position. Said random position could be any time point in a continuous program process. The user clicks on the bookmark, then the series of requests comprised in the bookmark are handled one by one in a batch-handling manner, thus the user could accurately and directly find the specific position in the specific program in an on-line manner on the web, just as convenient as using a conventional bookmark in a conventional book.

The invention further provides a method of creating the above e-bookmark. This method records, according to a predetermined order, the process of the user's browsing the specific program content on the web and stores it in a storing device. The stored content comprises a browsing command for requiring a specific server to send a specific program from an random position specified by a user. Said browsing command could comprise a series of requests, which may include a connection request for establishing connection with the server, wherein the program is stored in the server; and a playing request for requiring the server to send the specific program from the first random position. In the process of establishing, if the user ever has a plurality of playing requests during the browsing, those no longer needed by the user could be deleted before storing, whereas only the playing requests needed by the user are stored.

The invention further provides a media player, which has the function of creating said e-bookmark. Like the existing media player, said media player comprises means for acquiring the media contents; means for playing the media contents; and further comprises an creating means for creating an electronic bookmark, The creating means comprises application-layer means for sending a browsing command for requiring a specific server to send a specific program from a first random position specified by a user; and storing means for storing the command to create an corresponding electronic bookmark.

The present invention solves the technical problem of accurately and directly finding the specific position of the specific content through an e-bookmark on the web in an on-line manner so that the user could conveniently mark the content stored on the web for future searching.

The other objects and achievements of the present invention will be obvious, and the present invention could be better understood when reference is made to the following illustration of the drawings and the claims.

### BRIEF DESCRIPTION OF THE DRAWINGS

The present invention is elaborately explained with reference to the drawings through embodiments, wherein:

FIG. 1 is a general system schematic diagram of browsing the streaming media on the web under the control of RTSP methods;

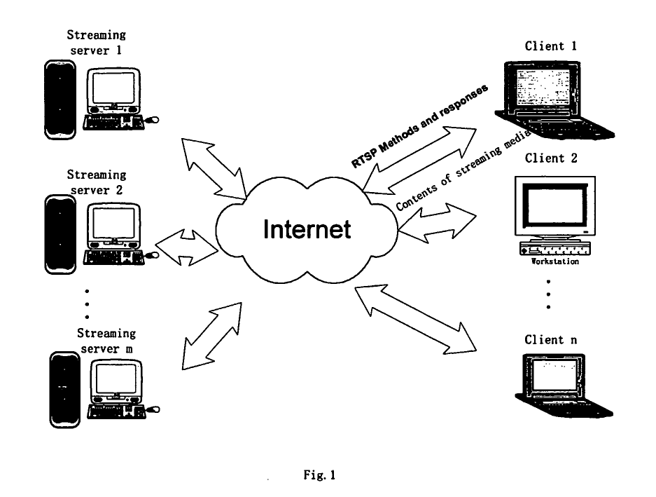

FIG. 2 is a system block diagram of a media player having the function of creating e-bookmark in accordance with an embodiment of the present invention;

FIG. 3 is a user interface of a media player in accordance with an embodiment of the present invention;

FIG. 4 is a flow chart of creating e-bookmark in accordance with an embodiment of the present invention;

FIG. 5 is a flow chart of applying e-bookmark in accordance with an embodiment of the present invention.

Through the drawings, the same reference numbers represent the same or similar features and functions.

### DETAILED DESCRIPTION OF THE PREFERRED EMBODIMENTS

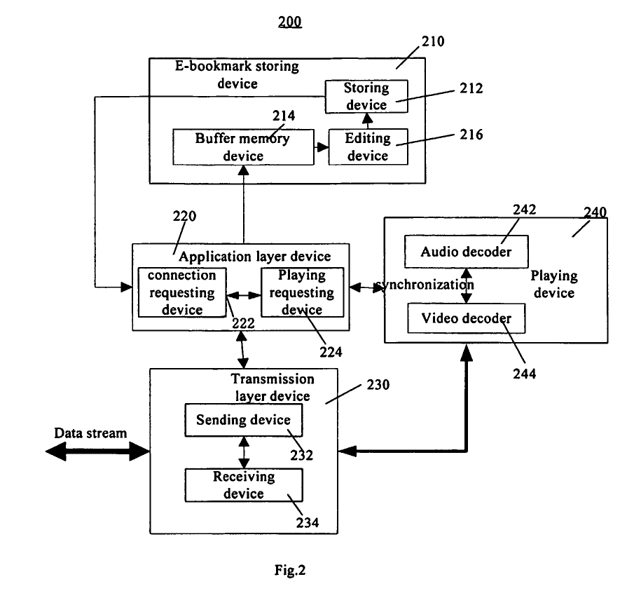

FIG. 2 is a system block diagram of a media player having the function of creating e-bookmark in accordance with an embodiment of the present invention. The media player 200 is mainly for playing web streaming media, comprising an application-layer device 220, a transmission-layer device 230, a playing device 240 and an e-bookmark storing device 210.

The application-layer device 220 comprises a connection requesting device 222, for sending a request, establishing connection through the transmission-layer device 230 with the server (not shown in the drawings) in which the specific program content is stored; a playing requesting device 224, for sending a request, requiring the server with which the connection has been established to send the program content from a random position specified by the user in said specific program. The two devices could be combined into one device, so long as a similar function is achieved. Said function is to play the program content in the specific position of a specific program according to the users demand.

The transmission-layer device 230 comprises a sending device 232, which could send the various requests from the application-layer device to the server by certain transmission protocol like TCP/IP (Transmission Control Protocol/Internet Protocol); and a receiving device 234, which could receive information from the web, including various streaming media content and transmission control information.

The playing device 240 comprises an audio decoder 242 and a video decoder 244, said device could play the media content sent from the receiving device 234.

The e-bookmark storing device 210 comprises a storing device 212, said device could store the series of requests from the application-layer device 220 into a storage medium in the form of a document in chronological sequence, and said storing device could be a hard disk drive (HDD), an optical disk drive (CD or DVD), a magnetic tape drive or other type of magnetic/optical storing device.

The e-bookmark storing device 210 further comprises an editing device 216, for editing said series of requests when storing them. Said editing device could have three functions, one is maintaining the playing request associated with the e-bookmark and deleting other playing request; second is modifying the information of specific playing position comprised in the playing request in said bookmark; and third is adding annotation information to the bookmark.

The e-bookmark storing device 210 could further comprise a buffer memory device 214, and before storing or editing said series of requests, buffering them into said device for further processing, and releasing said buffer memory device 214 when the play ends. Said buffer memory device 214 could also be integrated in the editing device 216 or the storing device 212.

The e-bookmark storing device 210 and the application-layer device 220 could together form a part of the creating device of the e-bookmark.

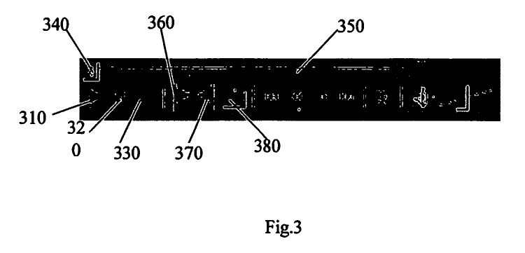

FIG. 3 is a user interface of a media player in accordance with an embodiment of the present invention. Said user interface is a user interface implementing an embodiment of the present invention in the form of software.

Button 310 in the figure is a play button, and a click on this button could make the media player 200 start playing; button 320 is a pause button, and a click on this button could make the media player pause playing; button 330 is a stop button, and a click on this button could make the media player stop playing. When the program is in play, the user could change the playing position at will by dragging the slide 340 on time bar 350.

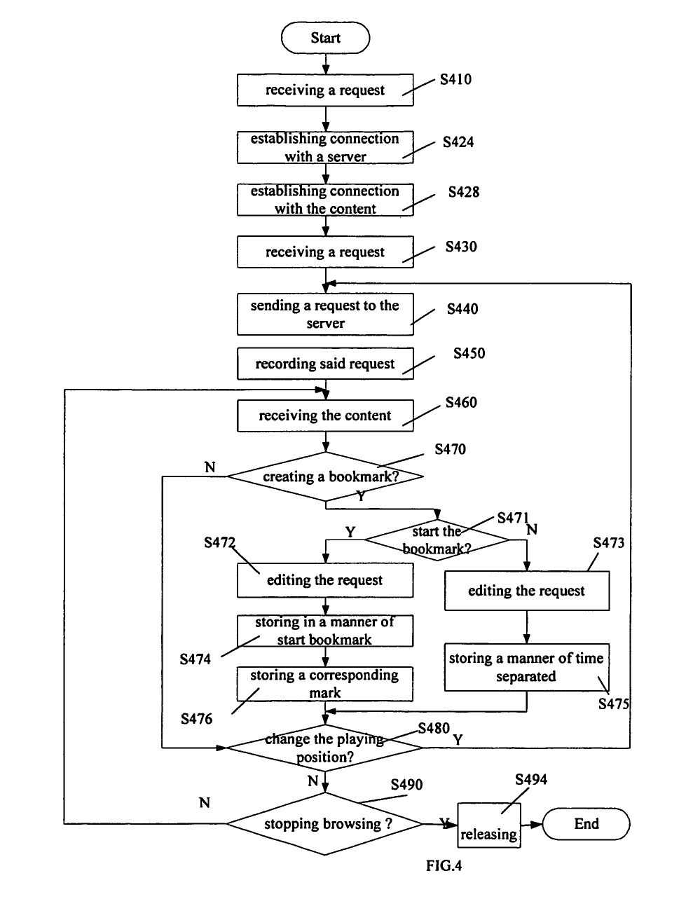

Button 360 is a button for creating start bookmark, and a click on this button could make the media player 200 create a start bookmark in the clicked playing position according to the method of the present invention. Next time the user clicks on the bookmark could make the media player directly start playing from this playing position. The method of creating a start bookmark is illustrated in FIG. 4.

Button 370 is a button for creating duration bookmark, and a click on this button could make the media player create a stop playing mark in the clicked playing position according to the method of the present invention. Said mark could form a duration bookmark with any preceding start bookmark. Next time the user clicks on the duration bookmark could make the media player directly play this fragment. The method of creating a duration bookmark is illustrated in FIG. 4.

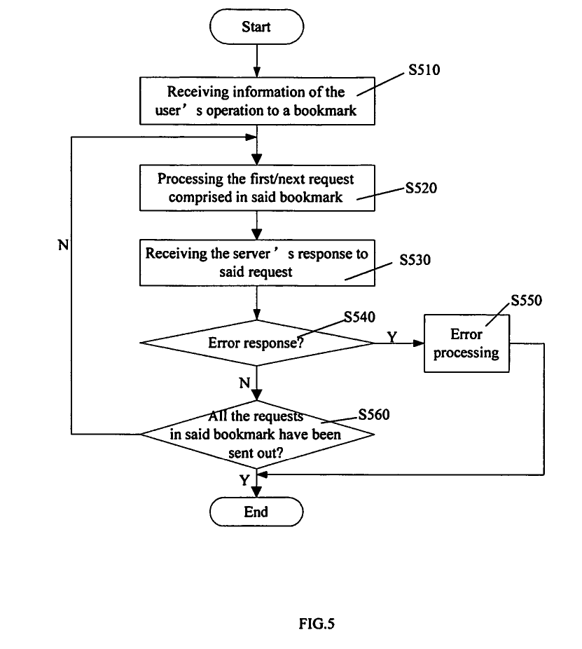

Button 380 is a bookmark favorites button, and a click on this button could make the media player present all the bookmarks associated with the media content to the user, including the start bookmark and the bookmark combination. The user selects one of the bookmarks, then the one bookmark will perform its specific playing function. The method of performing is illustrated in FIG. 5. Certainly, the user could select a plurality of bookmarks to automatically implement these bookmarks in a predetermined sequence, thus the user's favorite fragments could be played in succession accordingly.

FIG. 4 is a flow chart of creating e-bookmark in accordance with an embodiment of the present invention. First, the media player receives a request for browsing a specific program content (step S410), said specific program content, namely twister, is stored on www.example.com, the website of a server. The media player sends a RTSP request for establishing connection with said server according to the received user request (step S424). The content of said request is illustrated by RTSP method 1 in table 1.

TABLE 1
A Browsing Process Using RTSP Methods

| | |
|---|---|
| C→W: GET /twister.sdp HTTP/1.1 | RTSP method 1 |

Host: www.example.com
Accept: applicaton/sdp

| | |
|---|---|
| W→C: HTTP/1.0 200 OK | RTSP response 1 |

Content-Type: applicaton/sdp...

```
  m=audio 0 RTP/AVP 0
  a=control:rtsp://audio.example.com/twister/audio.en
```

| | m=video 0 RTP/AVP 31 | |
|---|---|---|
| | a=control:rtsp://video.example.com/twister/video | |
| C→A: SETUP rtsp://audio.example.com/twister/audio.en RTSP/1.0 | | RTSP method 2 |
| | Cseq: 1 | |
| | Transport: RTP/AVP/UDP;unicast;client_port=3056-3057 | |
| A→C: RTSP/1.0 200 OK | | RTSP response 2 |
| | ... | |
| C→V: SETUP rtsp://video.example.com/twister/video RTSP/1.0 | | RTSP method 3 |
| | Cseq: 1 | |
| | Transport: RTP/AVP/UDP;unicast;client_port=3058-3059 | |
| V→C: RTSP/1.0 200 OK | | RTSP response 3 |
| | ... | |
| C→V: PLAY rtsp://video.example.com/twister/video RTSP/1.0 | | RTSP method 4 |
| | Cseq: 2 | |
| | Session: 23456789 | |
| | Range: smpte=0:01:00- | The begin time |

is set to N1:

0:01:00 for video

| V→C: RTSP/1.0 200 OK | | RTSP response 4 |
|---|---|---|
| | ...Range: smpte=0:01:00-0:20:00... | |
| C→A: PLAY rtsp://audio.example.com/twister/audio.en RTSP/1.0 | | RTSP method 5 |
| | Cseq: 2 | |
| | Session: 12345678 | |
| | Range: smpte=0:01:00- | The begin time |

is set to N1:

0:01:00 for audio

| A→C: RTSP/1.0 200 OK | | RTSP response 5 |
|---|---|---|
| | ...Range: smpte=0:01:00-0:20:00... | |
| C→V: PLAY rtsp://video.example.com/twister/video RTSP/1.0 | | RTSP method 6 |
| | Cseq: 2 | |
| | Session: 23456789 | |
| | Range: smpte=0:02:00- | The begin time |
| | is set to N2: 0:02:00 for video | |
| V→C: RTSP/1.0 200 OK | | RTSP response 6 |
| | ...Range: smpte=0:02:00-0:20:00... | |
| C→A: PLAY rtsp://audio.example.com/twister/audio.en RTSP/1.0 | | RTSP method 7 |
| | Cseq:2 | |
| | Session: 12345678 | |
| | Range: smpte=0:02:00- | The begin time is |

set to N2:

0:02:00 for audio

| | |
|---|---|
| A→C: RTSP/1.0 200 OK | RTSP response 7 |

...Range: smpte=0:02:00-0:20:00...

Wherein, “C” represents a user, “W” represents a server, “A” represents the video content of the specific program on the server, while “V” represents the audio content of the specific program on the server.

Upon receiving the servers response to the request in step S424, the media player sends two requests, based on the content of said response, for establishing connection with the audio and video of the specific program content on said server (step S428). The content of said request is illustrated by RTSP methods 2 and 3 in table 1. When an “OK” response from the server is received, it means that the media player has established connection with the target media content and the preparation for play is ready.

Next, the media player receives the users request for playing the program content in the specific position (step S430), e.g. the content in position N1 (time is 0:01:00), the user could select said specific position by dragging the slide 340 on time bar 350. Said specific position could be a random time point in the whole program content. The user could also set the time default value of the first playing position of the media player as 0:00:00. The media player sends two corresponding RTSP requests to said server based on the content of the received user request (step S440). The content of said requests is illustrated by RTSP methods 4 and 5 in table 1, respectively requiring the server to sent the audio and video content in position N1 (time is 0:01:00) to the media player. The “Range:smpte=−0:20:00” in the server's response in table 1 indicates playing the program content between time position 0:01:00 and time position 0:20:00. The time position 0:01:00 is the start playing position, while the time position 0:20:00 is the end playing position of the whole program.

The above five requests could be integrated into one command, so long as the command could require the server to send program content from a random position, e.g. 0:01:00, in a specific program, i.e. twister, specified by a user. Certainly, as long as the transport protocols between the server and the media player support, the various requests in this embodiment could all be reasonably integrated into different commands.

At this moment, recording the five requests sent from media player during the connection process between the media player and server above, i.e. the RTSP methods 1, 2, 3, 4 and 5, in a buffer memory of the media player (step S450), and start receiving the program content from the server to play (step S460). Three requests comprising RTSP methods 1, 2 and 3 could also be included in one request as long as this request could perform the function of establishing connection with the specific program content on a specific server. Two requests comprising RTSP methods 4 and 5 could also be included in one request as long as this request could require the specific server with which the connection has been established to send the program content of a specific position in said specific program.

Next, determining if a users request for creating bookmark is received, the request requiring the creation of a bookmark in a specific browsing position of said specific program (step S470). If such a request is not received, further determining if a users request for changing the playing position in the specific program is received (step S480). As stated above, the user could select said specific position by dragging the slide 340 on time bar 350.

If a user's request for changing the playing position in the specific program is received in step S480, e.g. the user requests to change to position N2 (play time is 0:02:00) to play, then returning to step S440. The media player sends two requests to server www.example.com, requiring the server to send the audio and video program content in position N2 for play. The content of said requests is illustrated by RTSP methods 6 and 7 in table 1. At the same time, the two requests sent from media player during the connectioning process between the media player and server above, i.e. the RTSP methods 6 and 7, are recorded into a buffer memory of the media player (step S450), and the program contents starting from position N2 sent by the server are received to play (step S460).

If a request for creating a bookmark in a specific browsing position is received in step S470, e.g. in position B1 (play time is 0:03:00), further determining if the bookmark being requested to create is a start bookmark (step S471). The user could request to create a start bookmark in a specific browsing position by clicking the start bookmark creation button 360 during browsing. If yes, i.e. the user shows interest in the program content starting from position B1, the request in said buffer memory will be edited in the following way (step S472).

In this embodiment, the requests are RTSP methods 1 to 7, maintaining RTSP methods 1, 2 and 3, i.e. the requests that set up connection with the server www.example.com and the specific program content twister thereon, and deleting RTSP methods 4 and 5, i.e. the intermediate requests during browsing. Since the user may drag the slide several times to change the browsing position before deciding to create a bookmark, there might be a plurality of intermediate requests, maintaining the latest playing request RTSP methods 6 and 7, and changing the start playing position to 0:03:00, the edited content is shown in FIG. 2 (the RTSP methods in the table has been rearranged in order). If the user happens to select a playing position, to which an original playing request corresponds, to create a bookmark, it will be unnecessary to modify the start playing position comprised in said playing request, just deleting other playing requests will be enough.

The object of this maintaining and deleting step is to mark a playing request selected by the user. Said mark could also be implemented by adding a sign to the playing request to be maintained.

The edited content is stored in a storing device in the form of document (step S474). The storing device could be on the web, or be a local one. To distinguish from the following duration bookmark, said start bookmark document could have a specific icon; and storing a corresponding mark of the start bookmark in the buffer memory (step S476). During one browsing process, each bookmark created in a different position has a corresponding start bookmark. The start bookmark contains the time information of the start playing position to which said bookmark corresponds, and could be used when creating duration bookmark as below.

TABLE 2
A Start Bookmark

| | |
|---|---|
| C→W: GET /twister.sdp HTTP/1.1 | RTSP method 1 |

Host: www.example.com
Accept: applicaton/sdp

| | |
|---|---|
| C→A: SETUP rtsp://audio.example.com/twister/audio.en RTSP/1.0 | RTSP method 2 |

Cseq: 1
Transport: RTP/AVP/UDP;unicast;client_port=3056-3057

| | |
|---|---|
| C→V: SETUP rtsp://video.example.com/twister/video RTSP/1.0 | RTSP method 3 |

Cseq: 1
Transport: RTP/AVP/UDP;unicast;client_port=3058-3059

| | |
|---|---|
| C→V: PLAY rtsp://video.example.com/twister/video RTSP/1.0 | RTSP method 4 |

Cseq: 2
Session: 23456789

| | |
|---|---|
| Range: smpte=0:03:00- | The begin time |

is set to B1: 0:03:00 for video

| | |
|---|---|
| C→A: PLAY rtsp://audio.example.com/twister/audio.en RTSP/1.0 | RTSP method 5 |

Cseq: 2
Session: 12345678

| | |
|---|---|
| Range: smpte=0:03:00- | The begin time is |

set to B1: 0:03:00 for audio

If the result of determination in step S471 is that the bookmark requested by the user to create is not a start bookmark, e.g. said request is to make an end mark in position B2 (play time is 0:06:00), i.e. the end playing position, to create a duration bookmark, or in other words, the user shows interest in a fragment of program content before position B2, then the content in the buffer memory is edited in the following manner (step S473). The user could create a duration bookmark in a specific browsing position by clicking the duration bookmark creation button 370 during browsing.

To create a duration bookmark, the time information of the start playing position to which all the marks of start bookmark correspond in the buffer memory could be presented to the user at first, then the user's selection of start bookmark is received, and the start playing position to which the start bookmark selected by the user corresponds is taken as the start playing position of said duration bookmark. If there is no start bookmark in the buffer memory, 0:00:00 will be taken as the start playing position of said duration bookmark. The media player could also take the start playing position, to which a start bookmark that is closest to the end playing position of duration bookmark corresponds, as the default start playing position of said duration bookmark. This embodiment takes the start bookmark in position B1 as the user selected start bookmark.

During the process of creating said duration bookmark, maintaining RTSP methods 1, 2 and 3, i.e. the requests that set up connection with the server www.example.com and the specific program content twister thereon; deleting other requests during browsing, i.e. RTSP methods 4 and 5; maintaining the playing requests, i.e. RTSP methods 6 and 7, to which the user selected start bookmark corresponds, and changing its start playing position to 0:03:00, and end playing position to 0:06:00. The edited content is shown in table 3 (the RTSP methods in the table has been rearranged in order).

The edited content is stored in a storing device in a manner of document (step S475). The storing device could be on the web, or be a local one. To distinguish from the above start bookmark, said duration bookmark document could have a specific icon.

The playing request of the duration bookmark in this embodiment comprises a duration range (0:03:00-0:06:00). This request could be further divided into two requests, one comprises start playing position, 0:03:00, for requiring the server to send the program content of the specific program twister, starting from said position; the other comprises end playing position, 0:06:00, for requiring the server to stop sending the program content of the specific program twister from said position.

TABLE 3
A Duration Bookmark

| | |
|---|---|
| C→W: GET /twister.sdp HTTP/1.1 | RTSP method 1 |
| Host: www.example.com | |
| Accept: applicaton/sdp | |
| C→A: SETUP rtsp://audio.example.com/twister/audio.en RTSP/1.0 | method 2 |
| Cseq: 1 | |
| Transport: RTP/AVP/UDP;unicast;client_port=3056-3057 | |
| C→V: SETUP rtsp://video.example.com/twister/video RTSP/1.0 | method 3 |
| Cseq: 1 | |
| Transport: RTP/AVP/UDP;unicast;client_port=3058-3059 | |
| C→V: PLAY rtsp://video.example.com/twister/video RTSP/1.0 | method 4 |
| Cseq: 2 | |
| Session: 23456789 | |
| Range: smpte=0:03:00-0:06:00 | The duration is |
| set to B1 ˜ B2 for video | |
| C→A: PLAY rtsp://audio.example.com/twister/audio.en RTSP/1.0 | method 5 |
| Cseq: 2 | |
| Session: 12345678 | |
| Range: smpte=0:03:00-0:06:00 | The duration is |
| set to B1 ˜ B2 for audio | |

If the user's request for changing the playing position in said specific program content is not received in step S408, then further determining if the user's request for stopping browsing the specific program is received (step S490). The user could click stop button 330 to send said request. If the user's stopping request is not received, then returning to step S460 to continue receiving the program content from the server and play; if the user's stopping request is received, then releasing the content in the buffer memory and sending a request to the server, requiring it to stop sending program content to stop playing (step S494).

When or after creating bookmark, the user could mark said bookmark. The content of the mark could be “I love this fragment”, “this fragment is about MPEG system frame” or “this fragment is hard to understand and shall be consulted with the teacher” and the like. The manner of the mark could be stored in XML language, e.g.:

<userinfo>
I love this fragment!
</userinfo>

The user could also create a composite bookmark comprising multiple playing duration. The method is to add one or more duration playing requests to the bookmark edited in step S473. The start playing position and end playing position of each request are not identical or not completely identical with the start playing position and end playing position of another request.

FIG. 5 is a flow chart of applying e-bookmark in accordance with an embodiment of the present invention. First, receiving the user's selection operation to a bookmark (step S510). Said operation acts as a request for implementing an e-bookmark. The user could select the bookmark desired to be operated based on the bookmarks in bookmark favorite 380 stated in FIG. 3. Once the user selects a specific bookmark, the requests comprised in the bookmark would be sent one by one to the corresponding server of said request in turn (step S520), and receiving the server's response to said request (step S530).

Each time a response from the server is received, determining first if it is an error response (step S540); if it is, then conducting an error processing (step S550), e.g. providing an corresponding error prompt for the user; if it is not an error response, then further determining if all the requests in said bookmark have been sent to the server (step S560); if there are still requests not sent, returning to step S520 to process and send them to the corresponding server.

If the result of determination in step S560 is that all the requests in the bookmark have been sent to the server, the procedure of using this bookmark is thus ended. At this moment, the media player receives the program content sent from the server and plays. Said program content is the program content starting from the start playing position in said bookmark. If said bookmark is a start bookmark, the play will end after the whole program content is played; if said bookmark is a duration bookmark, the play will end at the end playing position in said bookmark. The embodiments of the present invention are all expounded in connection with RTSP protocols. In fact, the present invention could also be applied to other types of communication protocols, and so long as the requests sent by the user end could be recorded, the method of the present invention could be implemented.

Although the present invention is described through specific embodiments, many alternatives, amendments and variations made according to the above description will be obvious to those skilled in the art. Therefore, all these alternatives, amendments and variations shall be included in the present invention when they fall within the spirit and scope of the appended claims.

What is claimed is:

1. A method for creating an electronic bookmark during browsing a web, comprising:
(a) Sending a browsing command for requiring a specific server to send a specific program from a first random position specified by a user; and
(b) Storing the command to create an corresponding electronic bookmark.

2. The method according to claim 1, wherein the step (a) comprising:
Sending a connection request for establishing connection with the server, wherein the program is stored in the server, and
Sending a playing request for requiring the server to send the specific program from the first random position.

3. The method according to claim 2, further comprising:
Sending a second playing request for requiring the server to send the program from a second random position specified by the user; and
Identifying one of the playing requests.

4. The method according to claim 1, further comprising the step of;
Modifying information of the position in the browsing command to a second random position specified by the user.

5. The method according to claim 1, wherein the browsing command further comprising an position information of end of playing the program, the position information requires the server to stop playing the program at the a second random position specified by the user.

6. The method according to claim 5, further comprising:
Modifying the position information to a third random position specified by the user.

7. The method according to claim 1, wherein the step (a) further comprising:
Sending a stopping request for requiring the server to stop sending the program at a second random position specified by the user.

8. The method according to claim 1, further comprising:
Storing an additional information associated with the electronic bookmark for explaining the electronic bookmark.

9. The method according to claim 1, wherein the browsing command is sent with RTSP (Real Time Streaming Protocol).

10. A system for creating an electronic bookmark during browsing in a web, comprising:
application-layer means for sending a browsing command for requiring a specific server to send a specific program from a first random position specified by a user; and
storing means for storing the command to create an corresponding electronic bookmark.

11. The system according to claim 10, wherein the application-layer means comprising:
sending means for sending a connection request for establishing connection with the server, wherein the program is stored in the server; and
request means for sending a playing request for requiring the server to send the specific program from the first random position.

12. The system according to claim 10, the browsing command further comprising an position information of end of playing the program, the position information requires the server to stop playing the program at the a second random position specified by the user.

13. The system according to claim 10, further comprising:
editing means for editing the browsing command.

14. The system according to claim 10, wherein the application-layer means is further arranged for sending a stopping request for requiring the server to stop sending the program at a second random position specified by the user.

15. The system according to claim 10, wherein the storing means is further used for storing an additional information for explaining the electronic bookmark.

16. A media playing apparatus, comprising:
means for acquiring the media contents;
means for playing the media contents; and
creating means for creating an electronic bookmark, comprising:
application-layer means for sending a browsing command for requiring a specific server to send a specific program from a first random position specified by a user; and
storing means for storing the command to create an corresponding electronic bookmark.

17. A method for using an electronic bookmark, comprising:
Receiving a request for requiring to execute the electronic bookmark;
Sending a browsing command according to the electronic bookmark to require a specific server to send an specific program from a first random position specified by a user.

18. The method according to claim 17, the browsing command further comprising an position information of end of playing the program, the position information requires the server to stop playing the program at the a second random position specified by the user.
